(19) United States
(12) Patent Application Publication
(10) Pub. No.: US 2009/0061985 A1
(43) Pub. Date: Mar. 5, 2009

(54) Gaming Machine

(75) Inventor: Yukinori INAMURA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE CORP., Tokyo (JP)

(21) Appl. No.: 12/202,657

(22) Filed: Sep. 2, 2008

(30) Foreign Application Priority Data
Sep. 3, 2007 (JP) JP2007-227645

(51) Int. Cl. A63F 9/24; A63F 13/00

(52) U.S. Cl. 463/20

(57) ABSTRACT

If a plurality of BONUS symbols are stopped on the display and a predetermined condition is satisfied, a main CPU awards a free game to a player. Prior to awarding the free game, the main CPU determines the number of free games to be awarded in accordance with the positioning patterns of the BONUS symbols which are stopped on a variable display portion.

### CROSS-REFERENCE TO RELATED APPLICATIONS

This application is based upon and claims a priority from the prior Japanese Patent Application No. 2007-227645 filed on Sep. 3, 2007, the entire contents of which are incorporated herein by reference.

### BACKGROUND

1. Technical Field

The present invention relates to a gaming machine which displays symbols in a variable and stopped manner. More particularly, the present invention refers to a gaming machine wherein a prize is awarded in accordance with a positioning pattern of symbols which are stopped and displayed.

2. Description of Related Art

Conventionally, some gaming machines having a symbol display portion provided with a plurality of symbol display areas award a special prize (JP lottery, shifting to a bonus game), if predetermined conditions are satisfied (for instance, the gaming machine disclosed in U.S. Pat. No. 6,517,433).

The above-mentioned predetermined conditions include the case that a symbol combination which is displayed in a stopped manner on a symbol display area constituting a activated pay line corresponds to a predetermined combination, or the case that the number of specific symbols which are displayed in a stopped manner on the symbol display area constituting the symbol display portion is equal to or higher than a predetermined number.

For instance, in the gaming machine disclosed in the U.S. Pat. No. 6,517,433, a bonus game is executed in case where a specific symbol or a specific symbol combination appears on a pay line (e.g., activated pay line) with respect to which a game value was bet.

In the above-mentioned conventional gaming machine, a special prize which has the same contents all the time is awarded if predetermined conditions are satisfied. For instance, in the case of the gaming machine disclosed in the U.S. Pat. No. 6,517,433, a special prize (in this case, bonus game) is awarded when a specific symbol combination appears on the activated pay line. The contents of the special prize which is awarded are always the same, if predetermined conditions are satisfied.

Consequently, the conventional gaming machine has an advantage and a disadvantage. The advantage is that the presence or absence of the special prize can be easily grasped from the type and positioning pattern of the symbols which are displayed in a stopped manner on the symbol display. On the other hand, the disadvantage is that because the contents of the special prize are always the same, the game is likely to become monotonous.

The present invention has been worked out in view of the above-mentioned problems, and an object thereof is to provide a gaming machine wherein a special prize is awarded based on predetermined conditions, which makes it possible to easily grasp the presence or absence of the special prize. In addition, an object of the present invention is to provide a gaming machine which can increase a player's amusement by diversifying the contents of the special prize.

### SUMMARY

Therefore, in order to achieve the object, according to a first aspect of the present invention, there is provided a gaming machine having: a display onto which a symbol display area and a symbol display portion are displayed, the symbol display area displaying a plurality of types of symbols, including a special symbol, in a variable manner and stopped manner; and the symbol display portion being composed of a plurality of symbol display areas arranged in a matrix; and a processor which executes processes as follows: (a) a process of betting a gaming value and setting an activated pay line which is a target of the bet, from amongst a plurality of pay lines made up to include individual symbol display areas constituting respective columns in the symbol display portion; (b) a process of executing variable display and stopped display of symbols in the symbol display areas constituting the symbol display portion; (c) a process of awarding a first prize, if a symbol combination constituted of symbols which are stopped on the activated pay line is a special combination including special symbols, and on condition the activated pay line corresponds to a first pay line; and (d) a process of awarding a second prize which differs from the first prize, if a symbol combination made up of symbols which are stopped on the activated pay line corresponds to the special combination, and on condition the activated pay line corresponds to a second pay line which differs from the first pay line.

According to this gaming machine, if a special combination made up of a special symbol is stopped on an activated pay line, a special prize (for instance, a first prize or a second prize) is awarded to the player. Specifically, the player can easily grasp the presence or absence of a special prize by grasping a symbol combination on the activated pay line. As a result, the gaming machine can raise interest in the game with respect to awarding of a special prize.

The gaming machine awards a first prize if the activated pay line on which the special combination has been established corresponds to a first pay line. Then, the gaming machine awards to the player a second prize which differs from the first prize, if the activated pay line onto which the special combination has been established corresponds to a second pay line which differs from the first pay line. That is to say, to award a special prize, the gaming machine determines the contents of the special prize (first prize or second prize) in accordance with a positioning pattern in the symbol display areas constituting the activated pay line onto which a special combination is established. As a result, the player can no longer easily grasp the contents of the special prize. Accordingly, the gaming machine can offer interest to the player, such as surprise based on the contents of the special prize.

The contents of the special prize are determined in accordance with the above-mentioned positioning pattern. Thus, the gaming machine can add diversity to the special prize.

Further, according to the gaming machine, a sense of superiority can be experienced by a player who knows, and likewise, a player who does not know the associations between the contents of the special prize and the positioning patterns of the special symbols. This sense of superiority comes from the ability of the player to grasp the contents of the special prize based on the positioning pattern. As a result, the gaming machine can raise the interest of the players who know the above-mentioned associations, in the game.

According to one or more aspects of the present invention, there is provided a gaming machine having: a display onto which a symbol display area and a symbol display portion are displayed, the symbol display area displaying a plurality of types of symbols, including a special symbol, in a variable manner and stopped manner; and the symbol display portion being composed of a plurality of symbol display areas arranged in a plurality of columns and a plurality of rows; and a processor which executes processes as follows: (a) a process of accepting a bet of a gaming value, and executing display of symbols on the respective symbol display areas in a variable manner and stopped manner; (b) a process of counting the symbols which are stopped on the symbol display portion for each symbol type; (c) a process of awarding a first prize, in case the number of special symbols is equal to or higher than a predetermined number, and on condition the positioning pattern of the special symbol on the symbol display portion corresponds to a first positioning pattern; and (d) a process of awarding a second prize which differs from the first prize, in case the number of special symbols is equal to or higher than a predetermined number, and on condition the positioning pattern of the special symbol on the symbol display portion corresponds to a second positioning pattern which differs from the first positioning pattern.

According to the gaming machine, if a predetermined number of or more special symbols are stopped on the symbol display portion, a special prize (first prize, second prize) is awarded to the player. Specifically, the player can easily grasp the presence or absence of a special prize based on the number of special symbols displayed in the symbol display portion. The gaming machine can thus raise a player's interest in the game.

In case a predetermined number of or more special symbols are stopped on the symbol display portion, the gaming machine awards a first prize to the player, if the positioning pattern of the special symbols as displayed on the symbol display area corresponds to a first positioning pattern. The gaming machine awards a second prize, which differs from the first prize, to the player, if the positioning pattern of the special symbols as displayed on the symbol display area corresponds to a second positioning pattern. That is to say, the gaming machine determines the contents of the special prize (first prize and second prize) in accordance with the positioning patterns of a predetermined number of or more special symbols as displayed on the symbol display portion. As a result, the player can no longer easily grasp the contents of the special prize. Accordingly, the gaming machine can offer interest to the player, such as surprise with respect to the contents of the special prize.

The contents of the special prize are determined in accordance with the positioning pattern. Thus, the gaming machine can add diversity to the special prize.

Further, according to the gaming machine, a sense of superiority can be experienced by a player who knows, and likewise, a player who does not know the associations between the contents of the special prize and the positioning patterns of the special symbols. This sense of superiority comes from the ability of the player to grasp the contents of the special prize based on the positioning pattern. As a result, the gaming machine can increase the interest of the players who know the above-mentioned associations, in the game.

### BRIEF DESCRIPTION OF THE DRAWINGS

FIG. 1 is an explanatory diagram concerning determining the contents of a free game which is awarded to the player as a bonus in a gaming machine according to one embodiment of the invention;

FIG. 2 is a perspective view showing an outer appearance of a slot machine in one embodiment of the present invention;

FIG. 3 is an explanatory diagram showing a reel display portion of a slot machine in one embodiment of the present invention;

FIG. 4 is an explanatory diagram showing a symbol display portion of a slot machine in one embodiment of the present invention;

FIG. 5 is a block diagram showing an internal configuration of a slot machine in one embodiment of the present invention;

FIG. 6 is a block diagram showing an internal configuration of a sub-control board in the slot machine;

FIG. 7 is an external diagram showing symbols which compose the respective reels of the slot machine in one embodiment of a present invention;

FIG. 8 is an explanatory diagram showing symbol rows which compose the respective reels of the slot machine in one embodiment of the present invention;

FIG. 9 is an explanatory diagram showing a state wherein reels bands are variably displayed in a variable display portion of the slot machine according to one embodiment of the present invention;

FIG. 10 is an explanatory diagram showing a state wherein symbols are stopped on a variable display of the slot machine according to one embodiment of the present invention;

FIG. 11 is an explanatory diagram showing a payout table of a slot machine according to a first embodiment;

FIG. 12 is a flow chart of a main control process program according to a first embodiment;

FIG. 13 is a flow chart of a main game process program according to the first embodiment;

FIG. 14 is an explanatory diagram showing a table including associations of code numbers and symbols in the slot machine according to the first embodiment;

FIG. 15 is an explanatory diagram showing a table including associations of random numbers and code numbers in the slot machine according to the first embodiment;

FIG. 16 is an explanatory diagram showing a table including associations of random numbers and symbols in the slot machine according to the first embodiment;

FIG. 17 is an explanatory diagram showing a table including associations of random numbers and winning combinations in the slot machine according to the first embodiment;

FIG. 18 is an explanatory diagram showing a bonus content determination table according to a first embodiment;

FIG. 19 is a flow chart of a bonus game process program in the first embodiment;

FIG. 20 is an explanatory diagram showing one portion of a pay line in the slot machine according to a second embodiment;

FIG. 21 is an explanatory diagram showing a payout table of a slot machine according to the second embodiment; and

FIG. 22 is an explanatory diagram showing a bonus content determination table according to the second embodiment.

### DETAILED DESCRIPTION

### First Embodiment

Hereinafter, a detailed description will now be given with respect to an embodiment wherein a gaming machine according to the present invention is applied to a slot machine 1, based on the accompanying drawings.

A slot machine according to a first embodiment has an image display device such as a liquid crystal display or the like. Specifically, the slot machine includes a so-called video slot machine wherein a game is performed by displaying images of various types of symbols onto the image display device.

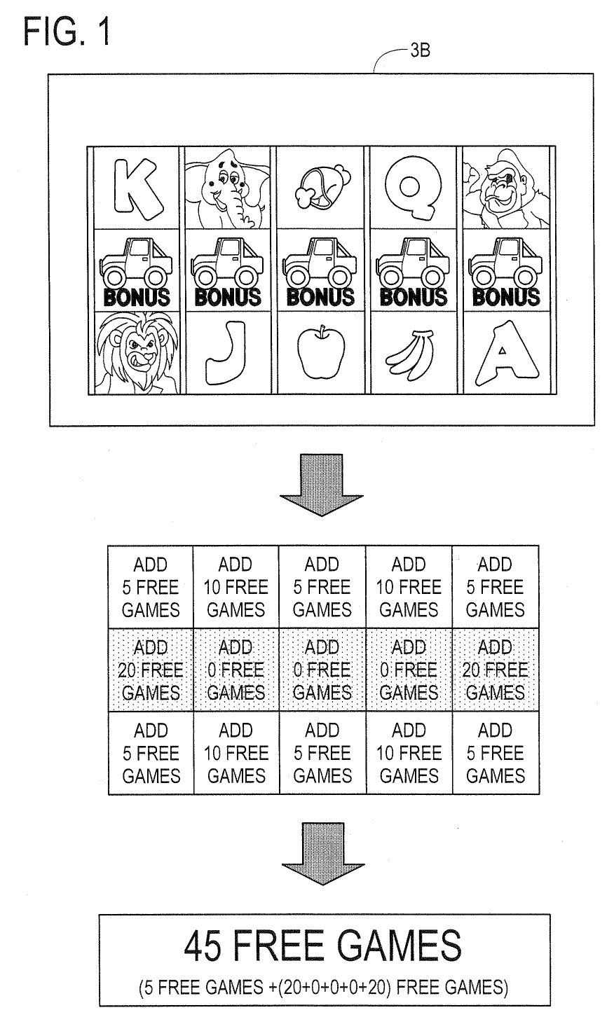

In the slot machine 1 according to the first embodiment, a so-called free game is awarded when a predetermined number of BONUS symbols 45G or more (in the present embodiment, five symbols) are stopped on a variable display portion 3B. At this time, the slot machine 1 determines the number of free games to be awarded in accordance with a positioning pattern of the BONUS symbol(s) 45G on the variable display portion 3B (specifically, symbol display area wherein the respective BONUS symbol(s) 45G is/are stopped). In the example shown in FIG. 1, the number of free games to be awarded is determined by adding the number of free games (40 games) to be awarded in accordance with a positioning pattern of the BONUS symbol(s) 45G with respect to the number of standard free games (5 games) which are awarded in principle. Accordingly, in the case of the example shown in FIG. 1, 45 free games are awarded to a player as a prize in accordance with the BONUS symbol 45G.

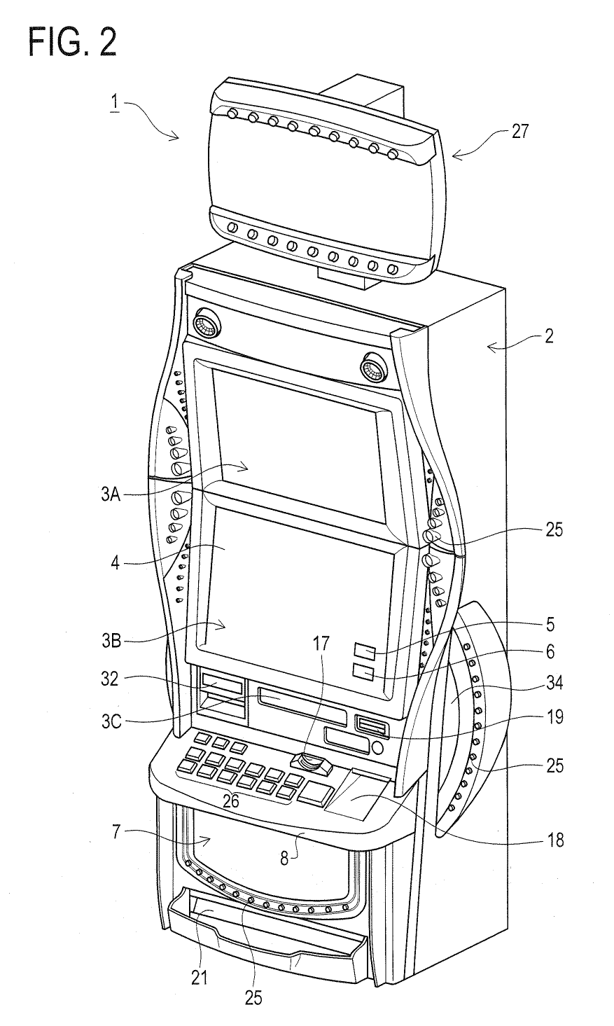

Next, a schematic configuration of the slot machine 1 according to the first embodiment will be described based on FIG. 2. FIG. 2 is a perspective view showing an outer appearance of a slot machine 1 according to the first embodiment.

The slot machine 1 according to the first embodiment is an upright-type slot machine which is installed in a game arcade such as a casino or the like. The outer appearance of the slot machine 1 as shown in FIG. 2 is simply one example thereof in the present invention, as is not limited to this.

As shown in FIG. 2, the slot machine 1 has a cabinet 2. The cabinet 2 serves as a housing portion which houses electrical or mechanical components which execute a predetermined game aspect.

The slot machine 1 has an upper display portion 3A, a variable display portion 3B and a lower display portion 3C provided at a front face of the cabinet 2. The upper display portion 3A, the variable display portion 3B and the lower display portion 3C display various types of game information.

The upper display portion 3A is made up of a liquid crystal panel and is installed at an upper level of the cabinet 2. The upper display portion 3A displays effect images, a payout table during the game and game rules.

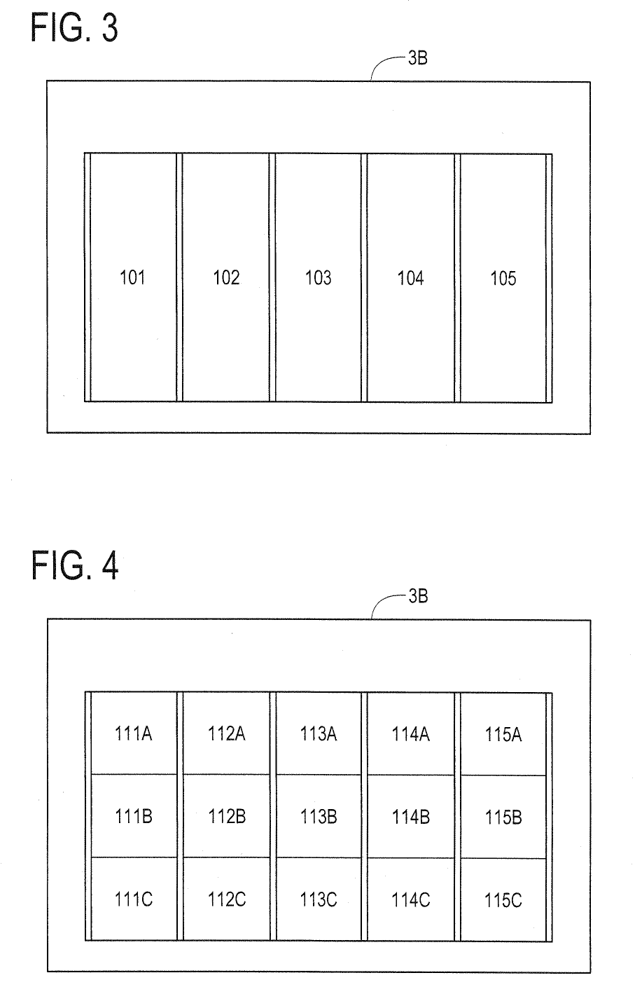

The variable display portion 3B is made up of a liquid crystal panel and is installed at a mid level of the cabinet 2. The variable display portion 3B has five reel display portions 101 through 105 (refer to FIG. 3). The reel display portions serve to display symbol rows in a variable manner and a stopped manner. The reel display portions 101 through 105 each have three symbol display areas. More specifically, the reel display portions 101 through 105 each have symbol display areas 111A through 111C, 112A through 112C, 113A through 113C, 114A through 114C and 115A through 115C. Each symbol display area displays one symbol (refer to FIG. 4). Specifically, the variable display portion 3B displays fifteen symbols in a 3×5 matrix. The number of reels and the number of display symbols in one reel display portion is variable.

The variable display portion 3B is provided with a touch panel 4 at a front face of the liquid crystal panel. The player operates the touch panel 4 to input various types of commands. The payout number display portion 5 and the credit number display portion 6 are provided at a right lower portion of the variable display portion 3B. The display positions on a payout amount display portion 5 and a credit amount display portion 6 are random. The variable display portion 3B can also be provided with a bet amount display portion for displaying a bet amount. The payout amount display portion 5 displays a payout amount to be awarded to the player (specifically, the payout amount to be awarded if predetermined conditions are satisfied in a normal game and the accumulated payout amount obtained during the free game). The credit amount display portion 6 displays the credit amount that the player possesses at present.

The lower display portion 3C is made up of a liquid crystal panel and is installed at a lower level of the cabinet. The lower display portion 3C displays the number of points which are stored on the card and the number of points acquired in the game. When the card is not inserted or when a failure occurs in reading the card, a message stating this fact is displayed on the lower display portion 3C.

Further, the card reading portion 19 is installed at a periphery of the lower display portion 3C. The card reading portion 19 reads out the information stored on the card that the player possesses.

As described above, in the first embodiment, the upper display portion 3A, the variable display portion 3B and the lower display portion 3C are made up of a liquid crystal display. However, they are not limited to this. For instance, the respective display portions can be made up of a CRT display, a plasma display, an LED display or other well known display devices.

A lower panel 7 is installed at a lower side of the lower display portion 3C. This lower panel 7 is made up of a plastic panel onto which images of the characters related to the gaming machines and the name of the gaming machine, etc. are drawn. The lower panel 7 is illuminated with back lights. The lower panel 7 can also be made up of a liquid crystal display, a CRT display, a plasma display, an LED display or other well know display devices.

The variable display portion 3B can also be made up of mechanical reels and a transparent liquid crystal display device which is installed at a front face of the mechanical reels. Specifically, the slot machine 1 can be constructed as a so-called hybrid-type gaming machine. In the case of such a machine, symbols which are drawn on the mechanical reels can be visualized through the transparent liquid crystal display device. Further, in the case of a hybrid-type gaming machine, the transparent liquid crystal display device is preferably designed so as to have a number of display windows which is equal to the number of mechanical reels provided therein and to allow visualization of the symbols drawn on the mechanical reels through the display windows.

It will be noted that the following description is given with respect to a gaming machine which uses video reels, however, the description can also be applied to gaming machines using mechanical reels, to the extent the present invention can be applied. In case mechanical reels are used, the mechanical reels are controlled for rotation and stopping by a motor which is not shown.

An operation table 8 is provided at a lower side of the variable display portion 3B. The operation table 8 has various operation buttons 26 (specifically, an EXCHANGE button, a RETURN button, a HELP button, a BET button, a START button and the like) provided therein. The operation table 8 also has a coin insertion portion 17 and a bill insertion portion 18.

The arrangement position of the operation buttons 26 is arbitrarily. Thus, a portion of the operation buttons 26 may be eliminated, as necessary, or otherwise, new buttons may be provided, or existing buttons may be replaced with others.

A coin payout port and a coin tray 21 are formed at a lower side of the cabinet 2. The coin payout port is a portion wherefrom coins are paid out upon depression of the EXCHANGE button or the PAYOUT button. The coin tray 21 is a portion for receiving the coins which are paid out from the coin payout port. The coin payout port has a coin detecting portion constructed of a sensor, etc. provided at an inner part thereof. The coin detecting portion detects the number of coins which are paid out from the coin payout port.

Further, a light emitting portion 25 is installed at a periphery of the cabinet 2 in the slot machine 1. This light emitting portion 25 lights up in a predetermined lighting pattern in case of a win or during the free game. Further, a speaker 34 for sound output is provided at a side face of the cabinet 2. The arrangement positions of the light emitting portion 25 and the speaker 34 are arbitrarily.

As shown in FIG. 2, the slot machine 1 has a topper effect device 27 provided at an upper side of the cabinet 2. The topper effect device 27 has a rectangular board shape and is arranged so as to be substantially parallel with the upper display portion 3A. The topper effect device 27 displays various types of information. The shape of the topper effect device 27 is arbitrarily.

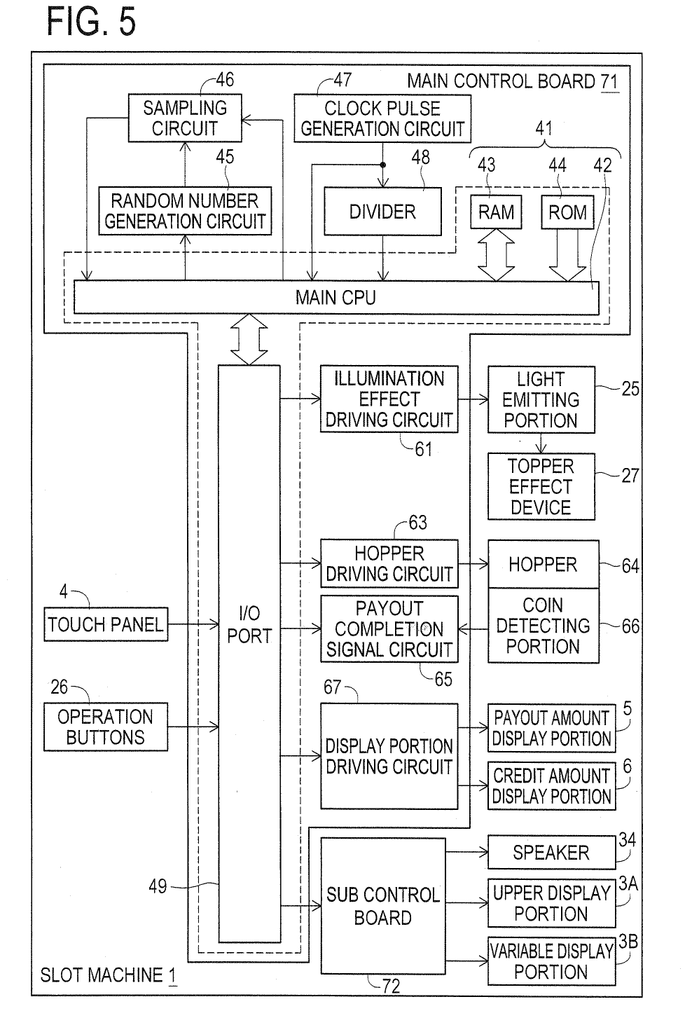

Next, an internal configuration of the slot machine 1 will now be described while referring to the drawings. FIG. 5 is a block diagram showing an internal configuration of the entire slot machine 1. As shown in FIG. 5, the slot machine 1 has a main control board 71 including a controller 41, as a main constituting element. The slot machine 1 further has a plurality of constituting elements. The main control board 71 has a controller 41, a random number generation circuit 45, a sampling circuit 46, a clock pulse generation circuit 47, a divider 48, an illumination effect driving circuit 61, a hopper driving circuit 63, a payout completion signal circuit 65 and a display portion driving circuit 67.

The controller 41 is made up of a main CPU 42, a RAM 43 and a ROM 44. The main CPU 42 operates in accordance with a program stored in the ROM 44 and carries out input/output of signals with the other constituting elements through an I/O port 49. As a result, the main CPU 42 controls the operation of the entire slot machine 1. The RAM 43 stores data and programs to be used by the main CPU 42 when operating. For instance, the RAM 43 temporarily holds random numbers which are to be sampled by the sampling circuit 46, after the game starts. The RAM 43 stores code numbers corresponding to the reel display portions 101 through 105. ROM 44 stores permanent data and various types of control programs to be executed by the main CPU 42.

The programs stored in the ROM 44 include game programs and game systems programs (hereinafter referred to as game programs, etc.). Further, the game program includes a lottery program.

This lottery program is executed at the time of determining the code numbers corresponding to the symbols which are stopped at a central position of the respective reel display portions 101 through 105 of the variable display portion 3B (specifically, symbol display areas 111B, 112B, 113B, 114B and 115B).

The lottery program includes symbol weighing data. The symbol weighing data includes data which shows associations between the respective code numbers and one or a plurality of random numbers within a predetermined range (for instance, 0 through 255). Specifically, one code number is associated with one or a plurality of random numbers, thus setting a lottery probability with respect to the symbols on the reel band. When a random number is extracted by lottery, a symbol which is finally identified from the plurality of random values is displayed in a predetermined area on the variable display portion 3B.

The random number generation circuit 45 operates in response to a command from the main CPU 42 to generate random numbers within a fixed range. The sampling circuit 46 extracts a random number, at random, from the random numbers generated by the random number generation circuit 45, in response to a command from the main CPU 42 and then inputs the random number thus extracted to the main CPU 42. The clock pulse generation circuit 47 generates a reference clock for causing the main CPU 42 to operate. The divider 48 inputs a signal obtained by dividing the reference clock by a predetermined period to the main CPU 42.

Further, the main control board 71 is connected to a touch panel 4. As described earlier, the touch panel 4 is arranged at a front face of the variable display portion 3B. The touch panel 4 identifies the coordinate position of the position which was touched by the player. Accordingly, the touch panel 4 can discriminate an operation (for instance, which portion was touched by the player and in which direction this portion has moved) carried out by the player based on the coordinate position information thus identified. A signal in accordance with the discrimination result is inputted to the main CPU 42 through an I/O port 49.

The main control board 71 is connected to the operation buttons 26 (the above-described START button, etc.) for commanding execution of the game, through an operation switch. Accordingly, signals corresponding to depression of the respective operation buttons 26 are inputted to the main CPU 42 through the I/O port 49.

The illumination effect driving circuit 61 outputs an effect signal in response to an instruction from the main CPU 42 to cause the light emitting portion 25 and the topper effect device 27 to perform an illumination effect. The topper effect device 27 is connected to the illumination effect driving device 61 through the light emitting portion 25.

The hopper driving circuit 63 drives the hopper 64 in accordance with the control of the main CPU 42. The hopper 64 carries out a predetermined operation to pay out coins to the coin payout port. The coin detecting portion 24 calculates the number of coins which were paid out by the hopper 64 and inputs coin amount data thus calculated showing the number of coins to the payout completion signal circuit 65. The payout completion signal circuit 65 receives coin amount data from the coin detecting portion 24. Then, when the number of received coins reaches a set number of coins, the payout completion signal circuit 65 inputs a signal which notifies completion of coin payout to the main CPU 42. The display portion driving circuit 67 controls the display operation of the various display portions such as the payout amount display portion 5 and the credit amount display portion 6.

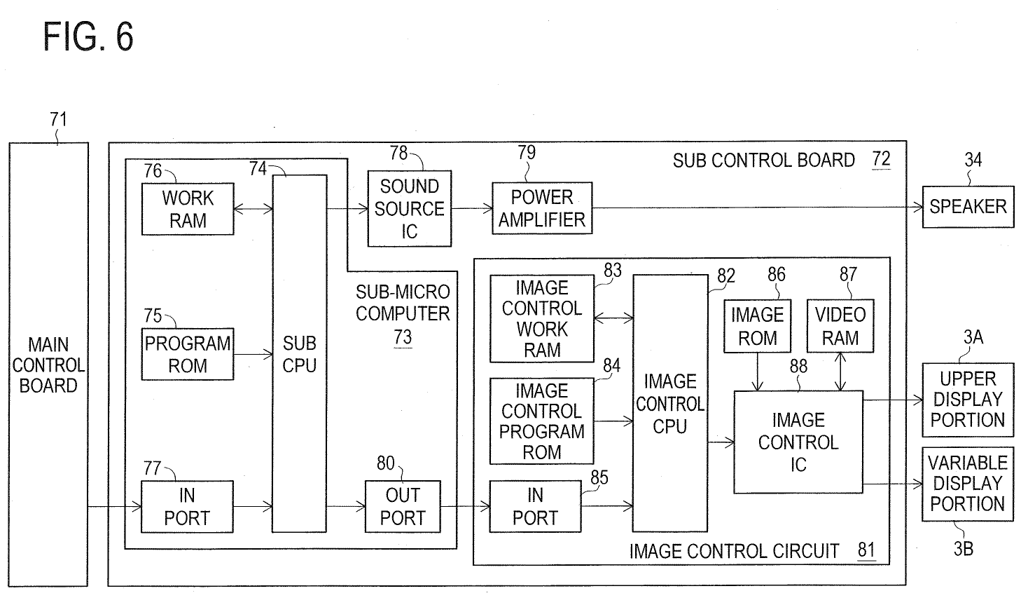

Further, the main control board 71 is connected to the sub-control board 72. As shown in FIG. 6, the sub-control board 72 controls display of the respective display portions and audio output from the speaker 34 in response to a command inputted from the main control board 71. The sub-control board 72 is constructed on a separate circuit board from the circuit board constituting the main control board 71. The sub-control board 72 has a microcomputer (hereinafter referred to as “sub-microcomputer 73”) serving as a main constituting element, and a sound source IC 78, a power amplifier 79 and an image control circuit 81. The sound source IC 78 controls the sound which is outputted from the speaker 34. The power amplifier 79 functions as an amplifier with respect to the sound outputted from the speaker 34. The image control circuit 81 operates as a display control device of the upper display portion 3A and the variable display portion 3B.

The sub-microcomputer 73 has sub CPU 74, program ROM 75, work RAM 76 and I/O ports 77 and 80. The sub-CPU 74 carries out a control operation in response to a control instruction which is transmitted from the main control board 71. The program ROM 75 stores a control program to be executed in the sub CPU 74. The work RAM 76 is constructed as a temporary memory at the time the sub CPU 74 executes the control program.

The sub-control board 72 does not include a clock pulse generation circuit, a divider, a random number generator and a sampling circuit. Random number sampling is carried out based on an operation program of the sub-CPU 74.

The image control circuit 81 has an image control CPU 82, an image control work RAM 83, an image control program ROM 84, an image ROM 86, a video RAM 87 and an image control IC 88. The image control CPU 82 determines an image to be displayed on the upper display portion 3A and the variable display portion 3B based on parameters set in the sub-microcomputer 73 and the image control program which will be described later. For instance, the image control CPU 82 displays a payout table and a help image on the upper display portion 3A. The image control CPU 82 carries out symbol display in a variable manner and stopped manner in the respective symbol display areas 111A through 111C, 112A through 112C, 113A through 113C, 114A through 114C and 115A through 115C of the variable display portion 3B.

The image control program ROM 84 stores image control programs and various selection tables with respect to display performed on the upper display portion 3A and the variable display portion 3B. The image control work RAM 83 functions as a temporary memory at the time the image control CPU 82 executes the image control program.

The image control IC 88 forms an image in accordance with the contents determined by the image control CPU 82 and outputs the image to the upper display portion 3A and the variable display portion 3B. The image ROM 86 stores dot data for forming an image. The video RAM 87 functions as a temporary memory device at the time the image control IC 88 forms an image.

The internal configuration of the slot machine 1 as described earlier represents merely one example thereof and is not limited to this. For instance, the slot machine 1 can accommodate the memory card and the PLD (Programmable Logic Device) in a removable manner. In this case, the slot machine 1 can be constituted so as to read out the necessary information from the memory card and the PLD.

The slot machine 1 according to the present invention employs coins, bills or electronic value information (credits) corresponding to coins or bills, as gaming values. The gaming values which can be applied to the present invention are not limited to the items mentioned above, but can also include, for instance, medals, tokens, electronic money and tickets.

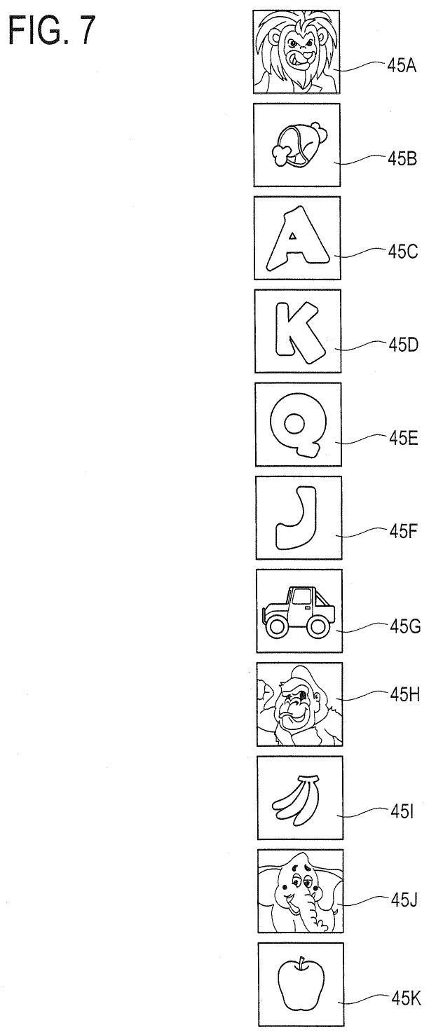

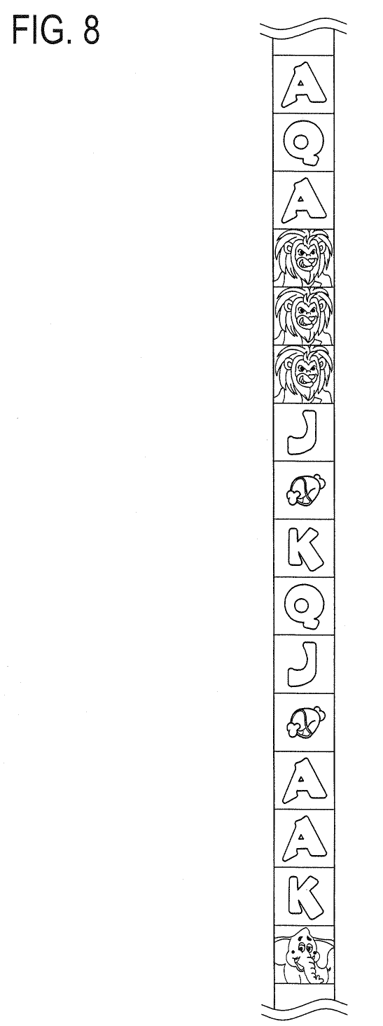

Next, the symbols which are drawn on the reel bands which are variably displayed in the reel display portions will be described in detail while referring to the drawings. FIG. 7 is a view showing one example of symbols which are drawn on the reel band which is variably displayed on the reel display portions 101 through 105. FIG. 8 shows a reel band (outside reel) which is variably displayed in each reel display portion.

As shown in FIG. 7 and FIG. 8, the reel band in the present embodiment includes a LION symbol 45A, a MEAT symbol 45B, an A (Ace) symbol 45C, a K (King) symbol 45D, a Q (Queen) symbol 45E, a J (Jack) symbol 45F, a BONUS symbol 45G, a GORILLA symbol 45H, a BANANA symbol 45I and an ELEPHANT symbol 45J, an APPLE symbol 45K.

As shown in FIG. 8, the various types of symbols shown in FIG. 7 are drawn on the reel band in a predetermined sequence. The reel band shown in FIG. 8 is merely an example thereof; the sequence of the symbols may be arbitrarily. The number of symbols which are drawn on one reel band may be arbitrarily; the type of the symbols may be arbitrarily as well.

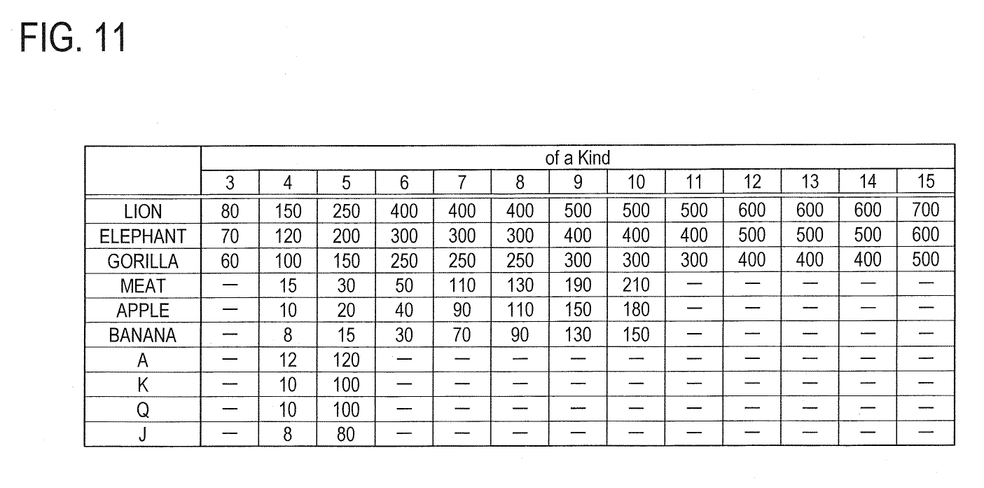

Next, a game which is to be executed in the slot machine 1 will now be described. In the game which is to be executed in the slot machine 1 according to the first embodiment, all symbols are scatter symbols. That is, in the game according to the first embodiment, a prize is awarded based on the number of identical symbols which are stopped on the symbol display areas 111A through 111C, 112A through 112C, 113A through 113C, 114A through 114C, 115A through 115C in a 3×5 matrix on the variable display portion 3B (refer to FIG. 11).

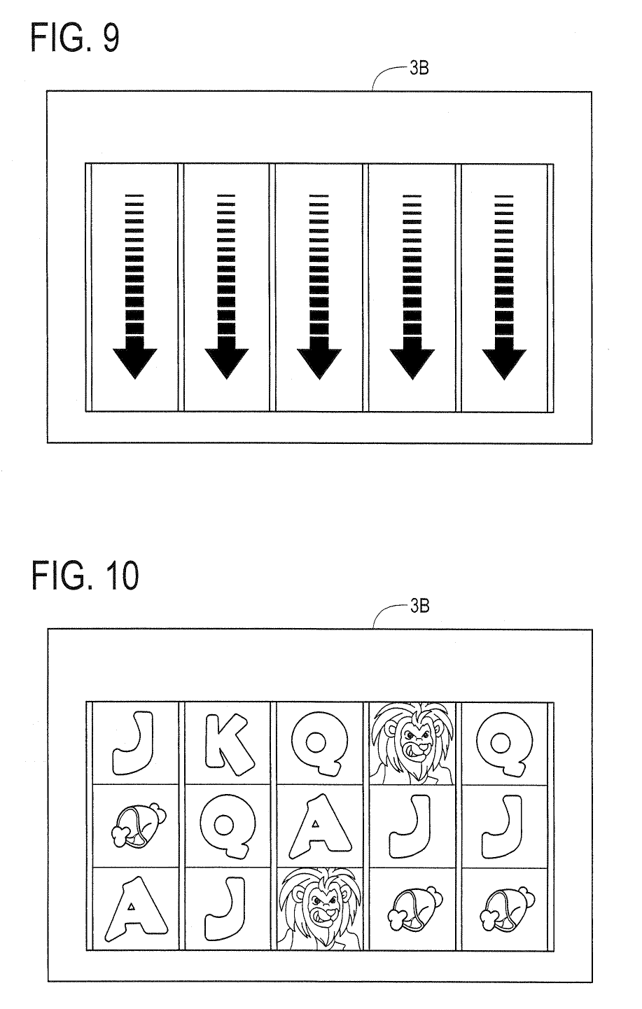

At the start of the game in the slot machine 1, the player operates the BET button to set the bet amount, after which, he/she depresses the START button. Then, the reel bands start rotating in the respective reel display portions 101 through 105. Specifically, the symbol rows which are drawn on the reel bands are displayed in a scrolled manner from the top in a downward direction in the respective reel display portions 101 through 105 (refer to FIG. 9).

After a predetermined period of time has passed, the reel bands are stopped on the reel display portions 101 through 105. Consequently, a portion of the respective reel band (three symbols constituting the respective reel bands) is stopped on the respective reel display portions 101 through 105. Specifically, as shown in FIG. 10, one symbol is stopped in each of three symbol display areas constituting each reel display portion. Thus, fifteen symbols are stopped on the variable display portion 3B (refer to FIG. 10).

The scrolling direction is not limited only to a downward direction, but may also include an upward direction. The scrolling direction can also be set to differ in each reel display portion. Further, the scrolling direction can also be set to differ in each game.

As described earlier, in the game according to the first embodiment, the winning combination is determined based on the number of identical symbols stopped on the variable display portion 3B. Then, a prize is awarded in accordance with the winning combination. In case of a winning combination, the player is awarded an amount obtained by multiplying the bet amount by the payout amount in accordance with the winning combination (refer to FIG. 11). This will be described later.

Next, the contents of the winning combination and the prize in the slot machine 1 according to the first embodiment will now be described while referring to the drawings. FIG. 11 is an explanatory diagram showing a payout table in the first embodiment.

As shown in FIG. 11, the payout table includes associations between winning combinations and corresponding prizes (e.g., payout amounts). The payout amount in the payout table shown in FIG. 11 shows the payout amount in the case that the bet amount is “1”. Specifically, if the bet amount is “1”, the payout amounts shown in FIG. 11 will be paid out. If the bet amount is “2” or more, an amount obtained by multiplying the bet amount by the payout amount as shown in FIG. 11 will be paid out.

For instance, if five “A” symbols 45C are displayed in fifteen symbol display areas (that is, symbol display areas 111A through 111C, 112A through 112C, 113A through 113C, 114A through 114C, and 115A through 115C) in the variable display portion 3B, “an amount obtained by multiplying 120 credits by the bet amount” is paid out to the player (refer to FIG. 11).

If four “J” symbols 45F are displayed in the fifteen symbol display areas in the variable display portion 3B, “an amount obtained by multiplying 8 credits by the bet amount” is paid out to the player (refer to FIG. 11). In the same manner, payout amounts are set for respective combinations as shown in FIG. 11.

In the first embodiment, if five or more BONUS symbols 45G are displayed in fifteen symbol display areas in the variable display portion 3B, the player is awarded a so-called free game, instead of a payout amount. Here, the free game is executed without the need for the player to bet new credits.

In the first embodiment, in a bonus content determination process (S18) to be described later, the contents of the current bonus game (e.g., the number of free games) is determined by adding the number of free games based on a positioning pattern of the BONUS symbol 45G displayed on the variable display portion 3B with respect to the number of standard free games “5”. Then, the player is awarded a number of free games which is equal to the determined number. This will be described in detail later.

If the symbols displayed on fifteen symbol display areas in the variable display portion 3B do not correspond to any of the winning combinations shown in FIG. 11, the player loses. In this case, there is no payout and no prize is awarded.

The payout table shown in FIG. 11 represents one example, and the type of winning combinations and the contents of the prize can be set as fit. For instance, the payout amount can be set as fit, as contents of the prize. Also, various types of bonus games (for instance, multiple-choice bonus game or the like) or a JACKPOT which differ from the free game can be awarded as a prize in the slot machine 1. Further, a plurality of payout tables can be provided and a selection can be carried out in accordance with a payout rate.

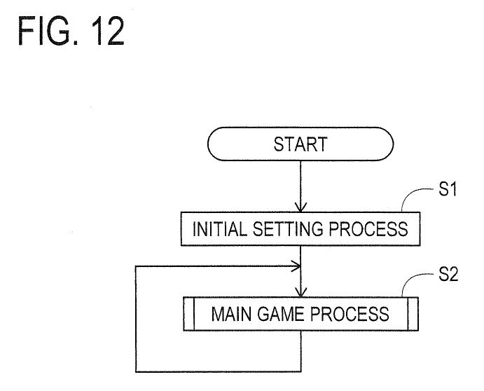

Next, the main control program to be executed in the slot machine 1 according to the present embodiment will now be described in detail while referring to the drawings. FIG. 12 is a flow chart of a main control program.

First, after depressing the power-on switch (upon power-on), the main control board 71 and the sub-control board 72 are activated. Then, the controller 41 executes an initial setting process (S1). In this initial setting process (S1), the main CPU 42 executes a BIOS stored in the ROM 44 and expands the compressed data which was incorporated in the BIOS in the RAM 43. Then, the main CPU 42 executes the BIOS expanded on the RAM 43, and the initialization and the diagnosis of the various periphery devices. Further, the main CPU 42 writes the game programs, etc. from the ROM 44 into the RAM 43, and acquires payout rate setting data and country identification information. The main CPU 42 also executes an authentication process with respect to the respective programs during execution of the initial setting process (S1).

Once the initial setting process (S1) is ended, the main CPU 42 executes the main game process (S2). In this main game process (S20), the main CPU 42 reads out the game programs, etc. from the RAM 43 sequentially, and then executes the game programs, etc. The game in the slot machine 1 according to the first embodiment is executed by executing this main game process (S2).

The main game process (S2) is repeatedly executed while power is being supplied to the slot machine 1.

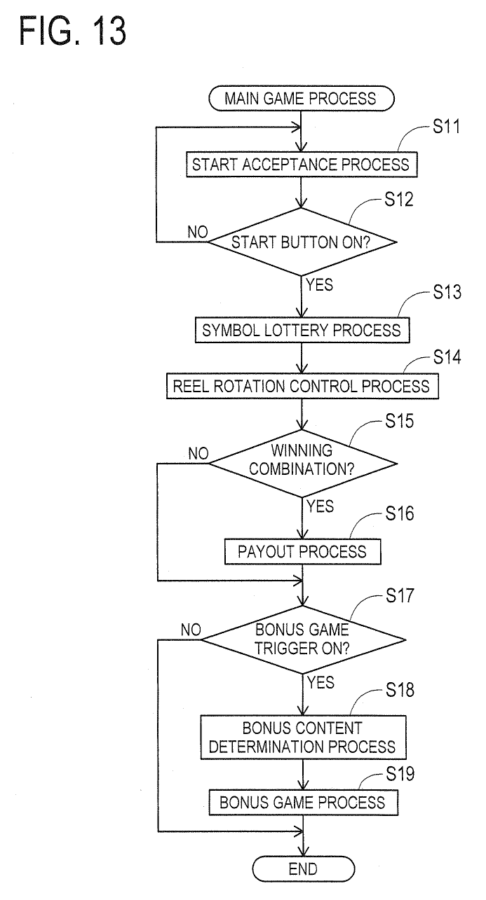

Next, the main game process programs to be executed in the main game process (S2) will be described while referring to the drawings. FIG. 13 is a flow chart of the main game process program in the slot machine 1 according to the first embodiment. The respective programs shown in the following flow chart are stored in the ROM 44 and RAM 43 provided in the slot machine 1 and are executed in the main CPU 42.

As shown in FIG. 13, the main CPU 42 first executes a start acceptance process (S11). In this start acceptance process (S11), insetting coins and a betting operation using the BET button from amongst the operation buttons 26 is carried out the player.

Then, after shifting to S12, the main CPU 42 judges whether or not the START button from the operation buttons 26 has been pressed. The main CPU 42 judges the presence or absence of a depression of the START button depending on the presence or absence of a signal based on depression of the START button. If the START button is depressed (S12: YES), the main CPU 42 subtracts the bet amount set based on the betting operation from the credit amount which the player possesses at present. At the same time, the main CPU 42 stores the result in the RAM 43 as bet information. Once subtraction of the credit amount and storing of the bet information has finished, the main CPU 42 shifts the process to S13. Alternatively, if the START button is not depressed (S12: NO), the main CPU 42 returns to the start acceptance process (S11). As a result, the player can carry out an operation to correct the bet amount.

After shifting to S13, the main CPU 42 executes a symbol lottery process. In this symbol lottery process (S13), the main CPU 42 executes a lottery program stored in the RAM 43 to sample a random value from a predetermined random number range. Then, the main CPU 42 determines the symbol to be stopped at central portions of the respective reel display portions (e.g., the symbol display areas 111B, 112B, 113B, 114B and 115B) based on the random value thus sampled and the table.

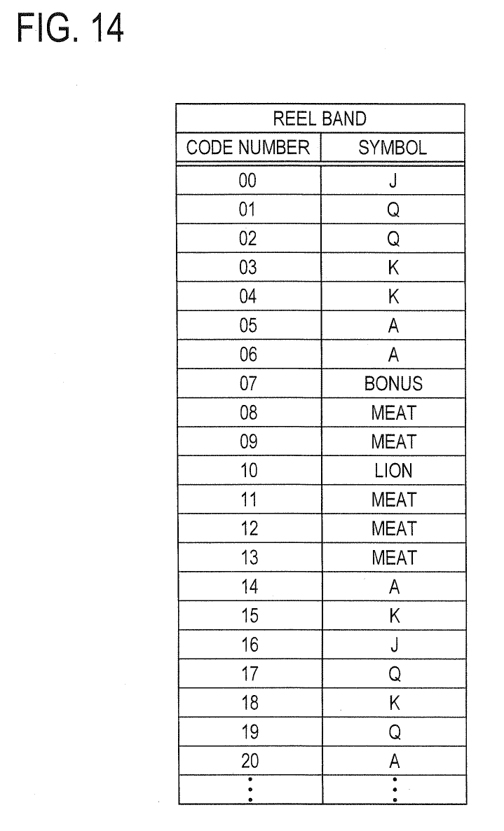

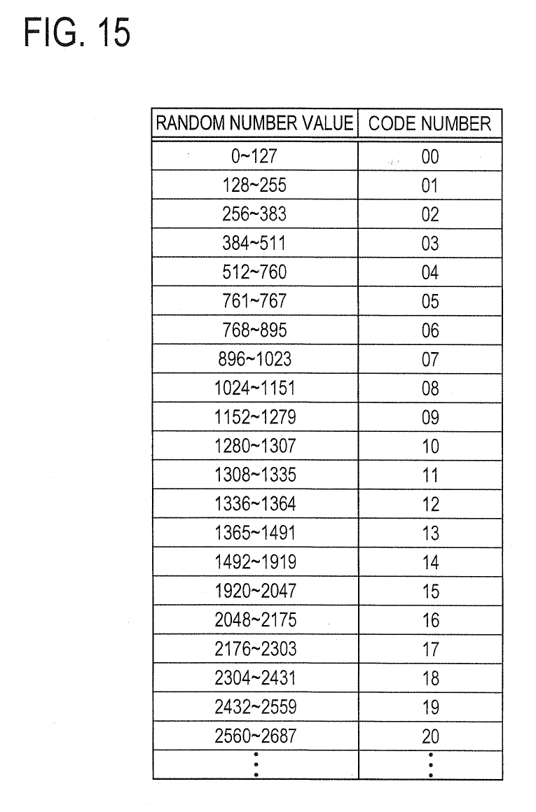

Next, a process wherein random numbers are used in the symbol lottery process (S13) will be described based on FIG. 13. FIG. 14 is one example of a table including associations between the symbols drawn on one reel band and the code numbers. FIG. 15 is one example of a table including associations between the random numbers and the code numbers.

The table including associations between the symbols and the code numbers (for instance, FIG. 14) exists in association with the respective reel display portions 101 through 105.

As described earlier, in the symbol lottery process (S13), the main CPU 42 executes the lottery program to sample random numbers within the predetermined random number range (for instance, 0 through 65535). Thereafter, a code number is determined based on the random numbers which were sampled and the table including associations between the random numbers and the code numbers (for instance, refer to FIG. 15). Once the code numbers are determined, the main CPU 42 determines the symbols to be stopped at the central portions on the reel display portions based on the code numbers and the table including associations between the symbols and the code numbers (refer to FIG. 14).

For instance, assuming a reel band as shown in FIG. 14 is used with respect to the reel display portion 101, if random number “1136” is sampled, the main CPU 42 selects code number “08” based on the random number “1136” and the table shown in FIG. 15. Then, the main CPU 42 sets the symbol to be stopped on the symbol display area 111B to the MEAT symbol 45B, based on the code number “08” and the table shown in FIG. 14.

Here, in the slot machine 1 according to the present embodiment, as shown in FIG. 15, the random values associated to the respective code numbers differ, enabling control of the appearance probability of each symbol as shown in FIG. 14. For instance, as shown in FIG. 15, random numbers “512” through “760” are associated to the code number “4”, and random numbers “761” through “767” are associated to the code number “5”. Specifically, the random number range for the code number “4” is broader than the code number “5”, which means that the code number “4” is more likely to appear as compared to code number “5”.

In the reel band shown in FIG. 14, K symbol 45D is associated to code number “4”, and A symbol 45C is associated to code number “5”. Thus, in the reel band shown in FIG. 14, the probability of display of the K symbol 45D corresponding to the code number “4” which is more likely to appear is higher as compared with the A symbol 45C corresponding to code number “5”.

The process using random numbers in the symbol lottery process (S13) is not limited to the process of using a table including associations between the random numbers and code numbers (for instance, refer to FIG. 15) and a table including associations between the symbols and code numbers (refer to FIG. 14).

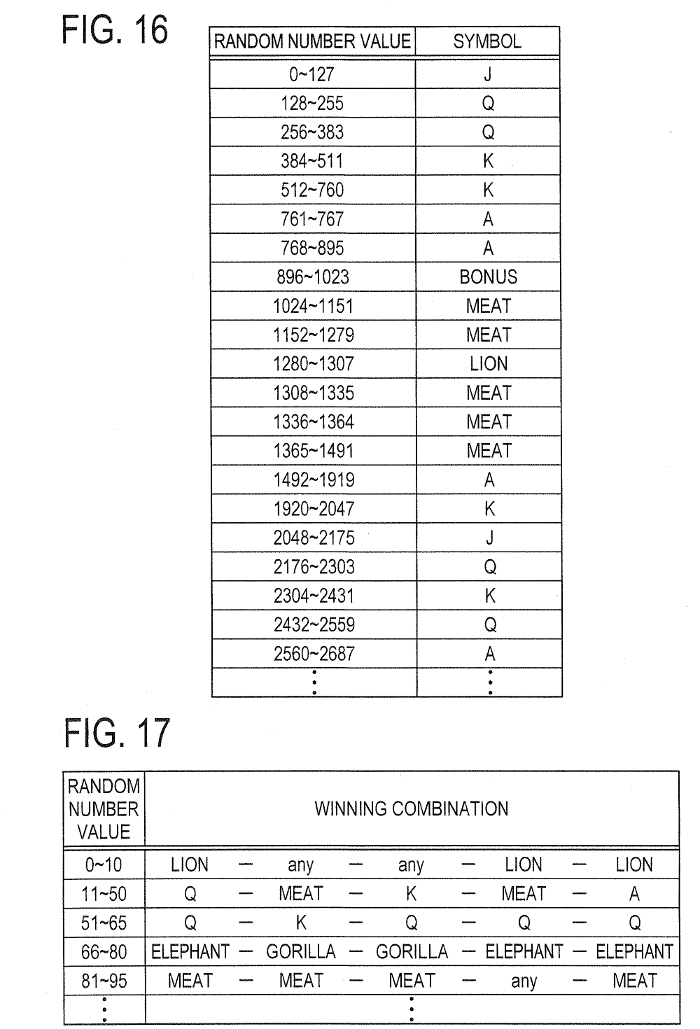

For instance, as shown in FIG. 16, the random number thus sampled may be directly associated with the symbols. As shown in FIG. 17, the random number thus sampled can be directly associated with the winning combination to determine the symbols to be stopped by using the table. In this case, the main CPU 42 determines the winning combination ahead based on the random number thus sampled, and then performs control so as to stop the symbol thus determined on the predetermined symbol display portion. In this case, if a random number which is not associated with the winning combination is sampled, the player loses.

Here, the processes in the main game process program which are executed after the symbol lottery process (S13) will be described while referring to FIG. 12.

After the symbol lottery process (S13) has finished, the main CPU 42 carries out a reel rotation control process (S14). In the reel rotation control process (S14), the main CPU 42 displays the respective reel bands on the reel display portions 101 through 105 in a variable manner at a predetermined speed. Then, the main CPU 42 determines an effect pattern with respect to a unit game (patterns for displaying images on the variable display portion 3B and outputting sound from the speaker 34). The main CPU 42 commands the sub-control board 72 to start the effects based on the effect pattern thus determined. Here, a unit game refers to a game carried out through a sequence of processes from the start of the variable display of the reel bands and until all reel bands are stopped.

After the passage of a predetermined period of time, the main CPU 42 stops the reel bands on the reel display portions 101 through 105 in a predetermined sequence. Thus, individual symbols are stopped on fifteen symbol display areas (e.g., symbol display areas 111A through 111C, 112A through 112C, 113A through 113C, 114A through 114C and 115A through 115C) in the variable display portion 3B. With respect to stopped display of the reel bands on the reel display portions, all reel display portions may be stopped at the same time, or otherwise, they may be stopped in order, with a certain time difference.

The display of stopped symbols will be described more specifically taking as example the reel display portion 101 as described in the symbol lottery process (S13). According to a specific example, the MEAT symbol 45B (code number: 8) which was determined in the symbol lottery process (S13) is stopped on the symbol display area 111B at a central portion of the reel display portion 101. In this case, a BONUS symbol 45G (code number: 7) is displayed on the symbol display area 111A constituting the upper side of the reel display portion 101. Then, the MEAT symbol 45B (code number: 9) is displayed on the symbol display area 111C constituting the lower side of the reel display portion 101.

After the reel rotation control process (S14), the main CPU 42 judges whether or not the symbols which were stopped on the variable display portion 3B correspond to a winning combination (S15). More specifically, the main CPU 42 judges whether these symbols correspond to a winning combination based on the code numbers of the reel display portions 101 through 105 stored in the RAM 43. In case the winning combination has been established (S15: YES), the main CPU 42 calculates the payout amount corresponding to the winning combination based on the payout table (refer to FIG. 11). Then, the main CPU 42 shifts the flow to S16. On the other hand, if no winning combination has been established (S15: NO), the main CPU 42 shifts the process to S17. If a new game is started thereafter, the processes after S11 are executed once again.

After shifting to S16, the main CPU 42 executes a payout process. In this payout process (S16), the main CPU 42 pays to the player a payout amount in accordance with the winning combination determined at S15. After this payout process (S16) has ended, the main CPU 42 shifts the process to S17.

In the following step S17, the main CPU 42 judges whether or not the start trigger of the bonus game has been established. More specifically, the main CPU 42 references the code numbers in the reel display portions 101 through 105 which were stored in the RAM 43. Based on this, the main CPU 42 judges whether or not “five or more BONUS symbols 45G have been stopped on fifteen symbol display areas constituting the variable display portion 3B”.

In case five or more BONUS symbols 45G are stopped to establish a start trigger for the bonus game (S17: YES), the main CPU 42 shifts the flow to a bonus content determination process (S18). On the other hand, if the start trigger of the bonus game is not established (S17: NO), the main CPU 42 ends the main game process program. As described earlier, the main game process program is ended, and simultaneously, it is executed again.

After shifting to S18, the main CPU 42 executes the bonus content determination process. In this bonus content determination process (S18), the main CPU 42 determines the details (e.g., number of free games) of the bonus game based on the positioning pattern of the BONUS symbols 45G which were stopped on the variable display portion 3B.

Here, the specific contents of the bonus content determination process (S18) will now be described in detail while referring to the drawing. As described earlier, the main CPU 42 can identify the types of the symbols which are stopped on fifteen symbol display areas by referring to the code numbers of the respective reel display portion 101 through 105 stored in the RAM 43. In other words, the main CPU 42 can identify the symbol display areas on which the BONUS symbols 45G are stopped (hereinafter referred to as bonus target areas) by referring to the code numbers of the respective reel display portion 101 through 105.

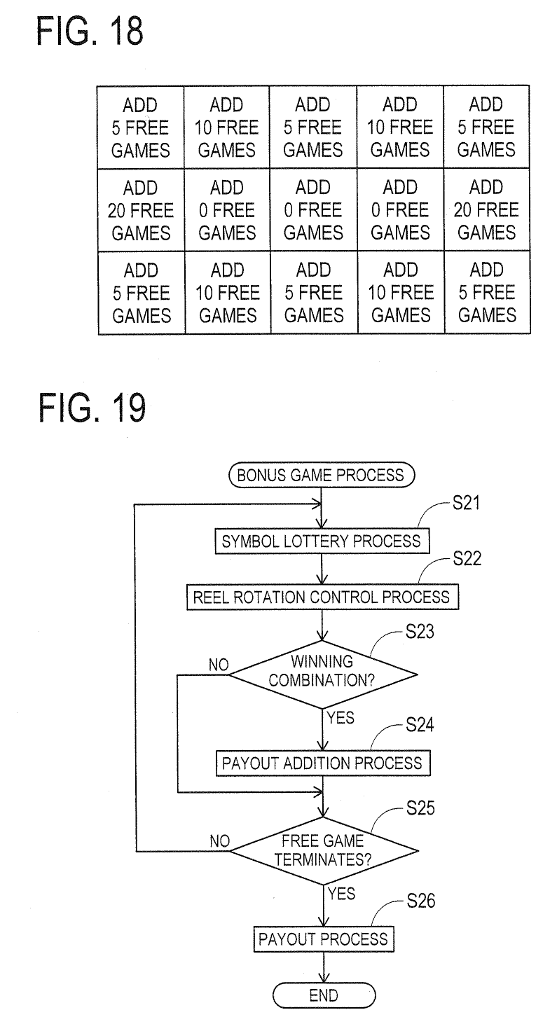

Then, in the slot machine 1 according to the first embodiment, the bonus content determination table shown in FIG. 18 is stored in the ROM 44. Here, the bonus content determination table is described in detail while referring to FIG. 18.

As shown in FIG. 18, in the bonus content determination table according to the first embodiment t, the number of free games to be added is associated with the symbol display areas 111A through 111C, 112A through 112C, 113A through 113C, 114A through 114C and 115A through 115C. For instance, “ADD 10 FREE GAMES (e.g., number of free games: +10)” is associated with the symbol display area 112A constituting the upper side of the reel display portion 102 (refer to FIG. 1, FIG. 18). Further, “ADD 5 FREE GAMES (e.g., +5)” is associated with the symbol display area 115C constituting the lower side of the reel display portion 105 (refer to FIG. 1, FIG. 18).

Accordingly, once the bonus target area is identified based on the code numbers of the respective reel display portions 101 through 105, the main CPU 42 can identify the contents of the bonus game (specifically, the number of free games) for the current game, based on the bonus target area thus identified and the bonus content determination table (refer to FIG. 18).

This will be now described in more detail based on the example shown in FIG. 1. In the case shown in FIG. 1, the BONUS symbol 45G is stopped on the symbol display areas 111B, 112B, 113C, 114B and 115B from amongst the fifteen symbol display areas constituting the variable display portion 3B. As described above, the main CPU 42 can identify the bonus target areas (in this case, symbol display areas 111B, 112B, 113C, 114B and 115B) by referring to the code numbers of the respective reel display portions.

Then, the main CPU 42 determines the number of free games in the current game based on the bonus target area thus identified and the bonus content determination table (refer to FIG. 18). As shown in FIG. 18, in the bonus content determination table, “ADD 20 FREE GAMES” is associated with the symbol display areas 111B and 115B which are bonus target areas, and “ADD 0 FREE GAMES” is associated with the symbol display areas 112B, 113B and 114B.

Accordingly, the main CPU 42 determines the number of free games in the current game, by adding the number of free games which are associated with the bonus target areas to the “number of standard free games: 5”, in an accumulative manner. In the case shown in FIG. 1, the main CPU 42 adds 40 games (20 games+0 games+0 games+0 games+20 games) to the “number of standard free games: 5”. Then, the main CPU 42 sets the number of free games in the current game to “45 games”.

After determining the number of free games in the current game based on the bonus target area and the bonus content determination table (refer to FIG. 18), the main CPU 42 stores the number of free games thus determined in the RAM 43. Then, the main CPU 42 shifts the flow to a bonus game process (S19).

In the following step S19, the main CPU 42 executes the bonus game process. In this bonus game process (S19), the main CPU 42 executes the so-called free game by a predetermined number times as determined in the bonus content determination process (S18). Then, the main CPU 42 awards to the player a prize based on the results of the free game. This bonus game process will next be described in more details while referring to the drawings. After the bonus game process (S19) has ended, the main CPU 42 ends the main game process program.

As described earlier, the main game process (S2) is repeatedly executed while power is being supplied to the slot machine 1. Specifically, once the main game process program has ended, the main CPU 42 starts execution of the main game process program once again.

Next, the bonus game process program to be executed in the bonus game process (S19) will now be described in detail while referring to the drawings. FIG. 19 is a flow chart of a bonus game process program.

The procedure of the free game to be executed in the bonus game process (S19) is essentially identical with a normal game. The difference between the two games is that in the free game, a gaming value (credit) corresponding to the bet amount is not used at the beginning of a game, and the game is continuously executed in an automatic manner without the need for the player to operate the operation button.

Once execution of the bonus game process program is started, the main CPU 42 first executes the symbol lottery process (S21). After the symbol lottery process (S21) has ended, the main CPU 42 shifts the flow to the reel rotation control process (S22). Then, the main CPU 42 executes the reel rotation control process. Then, once the reel rotation control process (S22) has ended, the main CPU 42 shifts the flow to process S23.

Here, the symbol lottery process (S21) and the reel rotation control process (S22) have the same contents as the symbol lottery process (S13) and the reel rotation control process (S14) in the main game process program. Thus, as the symbol lottery process (S21) and the reel rotation control process (S22) have already been described, and therefore, further description thereof is hereby omitted.

After shifting to S23, the main CPU 42 judges whether or not the symbols which are positioned on the variable display portion 3B correspond to the winning combination. More specifically, the main CPU 42 judges whether or not the symbols correspond to the winning combination based on the code numbers for the respective reel display portions 101 through 105 and the payout table (refer to FIG. 11) stored in the RAM 43. If the winning combination has been established (S23: YES), the main CPU 42 shifts the flow to process S24. Alternatively, if no winning combination has been established (S23: NO), the main CPU 42 shifts the flow to process S25.

At S24, the main CPU 42 executes the payout addition process. In this payout addition process (S24), the main CPU 42 sequentially adds the payout amount determined at S23 to the payout amount obtained in the bonus game process. The payout amount added in this payout addition process (S24) is paid out to the player in the payout process (S26) as will be described later.

At S25, the main CPU 42 first adds “1” to the count value of the counter for the number of free games which is formed in the RAM 43. Then, the main CPU 42 judges whether or not a free game completion condition is satisfied. That is, the main CPU 42 judges whether or not the free game has been executed by a predetermined number of times. Specifically, the main CPU 42 compares the number of free games (for instance, the number of free games determined in the bonus content determination process (S18)) which is currently set in the RAM 43 with the count value of the counter for the number of free games.

If the free game is executed by a predetermined number of times (S25: YES), the main CPU 42 shifts the flow to the payout process (S26). Specifically, in the slot machine 1, the free game is executed by a predetermined number of times which is currently set. As described earlier, the number of free games is determined in accordance with the positions of the BONUS symbols 45G which are stopped on the variable display portion 3B in the bonus content determination process (S18). Thus, the slot machine 1 can award to the player a number of free games which differs in accordance with the positioning patterns of the BONUS symbol 45G in the variable display portion 3B.

On the other hand, if the free game has not yet been executed by the predetermined number of times (S25: NO), the main CPU 42 returns the process to the symbol lottery process (S21). As a result, in the slot machine 1, one free game is executed once again.

After shifting to S26, the main CPU 42 pays to the player a payout amount obtained in the payout addition process (S24). In this payout process (S26), once the free game has been executed by the predetermined number of times, the resulting payout amount can be paid out in one time, or otherwise, the payout can be made in each free game.

During the execution of the free games, a judgment is made on the establishment of the bonus game trigger, and a “predetermined number of free games” can be awarded if the bonus game trigger has been established. In this case, the main CPU 42 may add, in an accumulative manner, the number of free games which was newly obtained, with respect to the current number of free games stored in the RAM 43.

Further, in this case, the bonus content determination process can also be executed in the free game. In this case, the number of free games as resulting in the accumulative addition process is set to a number in accordance with the positioning patterns of the BONUS symbol 45G which is stopped on the variable display portion 3B.

As described earlier, according to the slot machine 1 in the first embodiment, if five or more BONUS symbols 45G are stopped on the variable display portion 3B, “a free game” is awarded to the player as a bonus. Specifically, the player can easily judge the presence or absence of the “free game” depending on the “number of BONUS symbols 45G which are stopped on the variable display portion 3B”. Accordingly, the slot machine 1 can easily help the player judge the “presence or absence of the free game”, positively raising the interest of the player following award of the free game.

The slot machine 1 according to the first embodiment awards, in the bonus content determination process (S18), a bonus game with different contents (specifically, the number of free games), in accordance with the positioning patterns of the BONUS symbols 45G which are stopped on the variable display portion 3B. As a result, the player can no longer easily grasp the number of free games he/she will be awarded. Accordingly, the gaming machine can offer to the player more interest, such as surprise as to the number of free games he/she will be awarded.

According to the slot machine 1 in the first embodiment, the number of free games that will be awarded changes in accordance with the positioning patterns of the BONUS symbols 45G on the variable display portion 3B. This adds diversity to the contents of the prize which is to be awarded as a bonus.

Further, according to the slot machine 1, a sense of superiority can be experienced by a player who knows, and likewise, to a player who does not know, the associations between the number of free games to be awarded and the positioning patterns of the BONUS symbols 45G. This sense of superiority comes from the ability of the player to quickly grasp the number of free games he/she will be awarded. As a result, the slot machine 1 can raise the interest of the players who know the above-mentioned associations, in the game.

In the slot machine 1 according to the first embodiment, the contents of the prize to be awarded in accordance with the positioning patterns of the BONUS symbols 45G in the variable display portion 3B is a differing number of “free games”. That is, according to the slot machine, the contents of the bonus in the slot machine 1 are set to “free game” uniformly. Thus, the slot machine 1 clearly gives the player(s) the impression that diverse bonuses are offered. As a result, the slot machine can raise the player's interest in the game.

### Second Embodiment

Next, an embodiment which differs from the first embodiment (hereinafter referred to as a second embodiment) described above will be described while referring to the drawings. First, the slot machine according to the second embodiment will be described.

In the following description, numerical symbols which are the same as those of the slot machine 1 according to the above-described first embodiment refer to elements which are the same as or elements corresponding to the elements in the slot machine 1 according to the above-described first embodiment.

The schematic configuration of the slot machine according to the second embodiment is substantially the same as that of the slot machine 1 according to the first embodiment. The various control processes as well are substantially the same as those in the slot machine 1 according to the first embodiment.

In the slot machine 1 according to the second embodiment, a so-called pay line-type game is executed. More specifically, in a game according to this second embodiment, a plurality of pay lines are set with respect to symbol display areas 111A through 111C, 112A through 112C, 113A through 113C, 114A through 114C and 115A through 115C which are arranged in a 3×5 matrix format on the variable display portion 3B. The player bets a gaming value with respect to a pay line arbitrarily. Then, the player is awarded a prize in accordance with the symbol combination which is stopped on the pay line that bet the gaming value (hereinafter referred to as activated pay line).

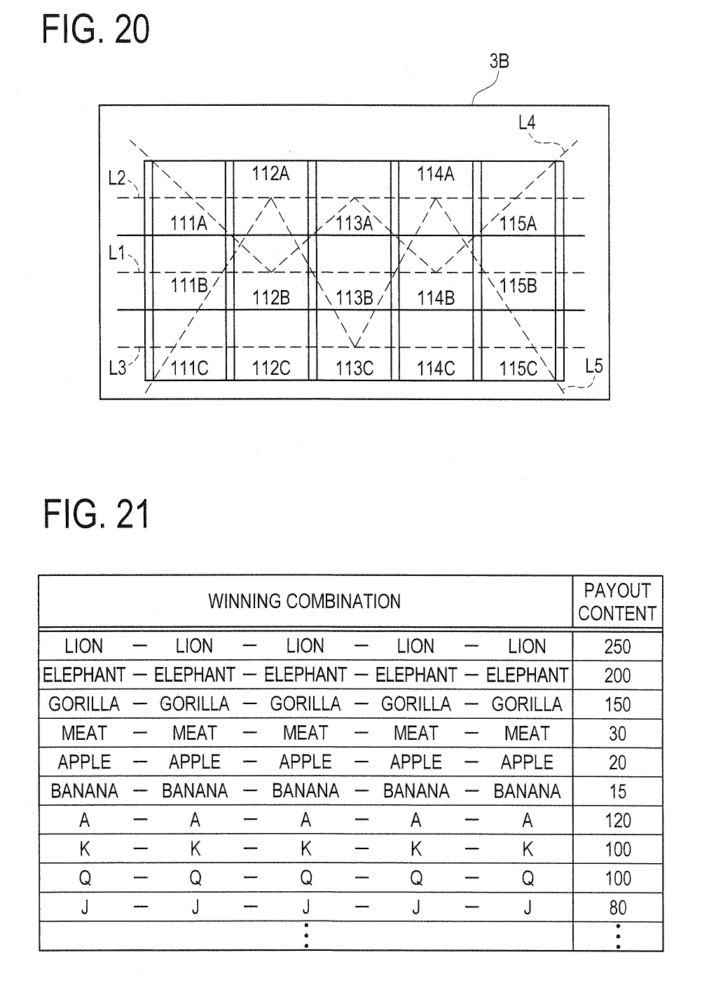

Here, the pay line in the slot machine 1 according to the second embodiment will be described in detail while referring to the drawings. FIG. 20 is an explanatory diagram showing one portion of the pay lines in the slot machine 1 according to the second embodiment.

In the slot machine 1 according to the second embodiment, a plurality of pay lines are set with respect to a variable display portion 3B. The pay lines are each defined so as to include individual symbol display areas, from amongst the symbol display areas constituting the respective reel display portions 101 through 105.

For instance, as shown in FIG. 20, a first pay line L1 is defined so as to include symbol display areas constituting a central portion of the respective reel display portions 101 through 105 (that is, symbol display areas 111A, 112A, 113A, 114A and 115A). Similarly, a second pay line L2 is defined so as to include the symbol display areas constituting the upper side of the respective reel display portions 101 through 105. A third pay line L3 is defined so as to include symbol display areas constituting the lower side of the respective reel display portions 101 through 105.

Specifically, the first pay line L1, the second pay line L2 and the third pay line L3 are defined so as to cross the central portion, the upper side and the lower side of the variable display portion 3B in a horizontal direction.

Then, in the second embodiment, the pay line is not limited to a pay line (for instance, first pay line L1 through third pay line L3) defined so as to cross the variable display portion 3B in a horizontal direction, but may include a pay line having various other shapes.

The fourth pay line L4 in the second embodiment is defined so as to include symbol display areas 111A, 112B, 113A, 114B and 115A (refer to FIG. 20). A seventh pay line L5 is defined so as to include the symbol display areas 111C, 112A, 113C, 114A and 115C (refer to FIG. 20). As shown in FIG. 20, the shape of the fourth pay line L4 and the seventh pay line L5 (e.g., the positioning patterns of the symbol display areas constituting the pay lines) differ.

Then, as shown in FIG. 20, the fourth pay line L4 and the seventh pay line L5 are defined so as to include one symbol display area from amongst the symbol display areas constituting the respective reel display portions 101 through 105.

In the second embodiment, the number of the pay lines can be set as desired. Setting of the plurality of pay lines is carried out based on operating a button (for instance, operating the PAY LINE button) from amongst the operation buttons 26. For example, in the slot machine 1 according to the second embodiment, the number of pay lines can be set to 25, 50 or 100 by operating the above-mentioned button.

The slot machine according to the second embodiment is controlled based on programs which are essentially the same as the main control process program (refer to FIG. 12), the main game process program (refer to FIG. 13) and the bonus game process program (refer to FIG. 19) according to the first embodiment.

However, in the second embodiment, the payout table, the contents of the bonus game trigger and the bonus contents determination table differ from the first embodiment.

Here, the main game process program in the second embodiment will next be described, focusing on these differences.

Once execution of the main game process program is started, the main CPU 42 executes a start acceptance process (S11), which is similar with the first embodiment. In the second embodiment, in the start acceptance process (S11), a number of pay lines setting process and an activated pay line setting process (e.g., gaming value betting process with respect to the pay line chosen by the player), in addition to the processes according to the first embodiment.

After the start acceptance process (S11) has ended, the main CPU 42 executes the judgment process at S12, the symbol lottery process (S13) and the reel rotation control process (S14). These processes are the same as those in the first embodiment, and therefore, description thereof is hereby omitted.

After the reel rotation control process (S14), the main CPU 42 judges whether or not the symbols stopped on the activated pay line correspond to a winning combination (S15). More specifically, the main CPU 42 judges whether or not the symbols correspond to the winning combinations, based on the code numbers of the reel display portions 101 through 105 stored in the RAM 43.

The payout table of the slot machine 1 according to the second embodiment includes associations between the winning combinations constituted of the symbols which are stopped on the activated pay line and the payout amounts with respect to these winning combinations (refer to FIG. 21). Accordingly, the main CPU 42 judges whether or not a winning combination defined in the payout table (refer to FIG. 21) is established based on the code numbers stored in the RAM 43.

If a winning combination is established (S15: YES), the main CPU 42 calculates the payout amount corresponding to the winning combination based on the payout table shown in FIG. 21 and the bet amount. Then, the main CPU 42 shifts the process to S16.

For instance, if a gaming value is bet on the fourth pay line L4, and this becomes the activated pay line, the main CPU 42 determines an amount obtained by multiplying “the bet amount with respect to the fourth pay line L4” to “120 credits” as a payout amount with respect to the fourth pay line L4, when the “A symbol 45C” is stopped on the symbol display areas 111A, 112B, 113A, 114B and 115A constituting the fourth pay line L4.

On the other hand, if no winning combination is established (S15: NO), the main CPU 42 shifts the process to S17. If a new game is started next, the main CPU 42 executes the processes following step S11 again.

After shifting to S16, the main CPU 42 executes the payout process, similarly with the first embodiment. In this payout process (S16), the main CPU 42 pays out to the player a payout amount in accordance with the winning combination determined at S15. After the payout process (S16) has ended, the main CPU 42 shifts the process to S17.

At the following step S17, the main CPU 42 judges whether or not a bonus game start trigger is established. Here, in the second embodiment, the fact that the “symbol combination which was stopped on the activated winning line is a special symbol combination” represents the bonus game start trigger. Then, the special symbol combination according to the second embodiment is established to “the case that the BONUS symbols 45G are stopped on five symbol display areas constituting the activated pay line”.

Accordingly, at S17, the main CPU 42 references the code numbers of the reel display portions 101 through 105 stored in the RAM 43 and the activated pay line setting state in the start acceptance process (S11). Then, the main CPU 42 judges whether “the special symbol combination has been established on the activated pay line”.

If a bonus game start trigger is established when a special symbol combination is established on the activated pay line (S17: YES), the main CPU 42 shifts the process to the bonus content determination process (S18). On the other hand, if the bonus game start trigger is not established (S17: NO), the main CPU 42 ends the main game process program. As described earlier, the main game process program is ended, and simultaneously, execution thereof is restarted.

After shifting to S18, the main CPU 42 executes the bonus content determination process. In this bonus content determination process (S18), the main CPU 42 determines the number of free games in accordance with the positioning patterns of the BONUS symbols 45G in the variable display portion 3B, as is the case with the first embodiment.

However, in the bonus content determination process (S18) according to the second embodiment, the main CPU 42 determines the number of free games using a bonus content determination table which differs from that of the first embodiment.

Here, in the second embodiment as well, the main CPU 42 can identify the type of symbols stopped on fifteen symbol display areas by referring to the code numbers in the reel display portion 101 through 105 stored in the RAM 43. Then, the main CPU 42 can identify which pay line corresponds to the activated pay line by referring to the setting status of the activated pay line stored in the RAM 43 in the start acceptance process (S11).

Specifically, the main CPU 42 can identify the “activated pay line on which the special symbol combination has been established (hereinafter referred to as bonus target line)” by referring to the code numbers of the reel display portions 101 through 105 and the setting status of the activated pay line.

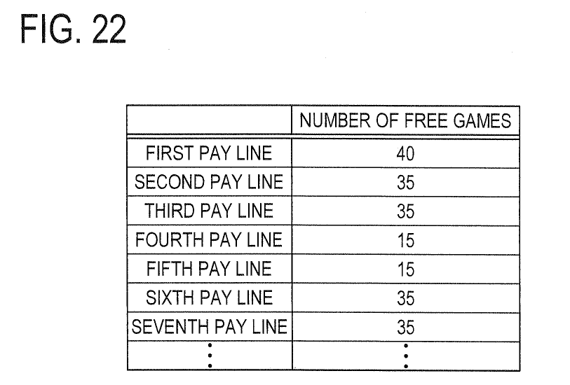

In the second embodiment as well, the bonus content determination table is stored in the ROM 44. Here, the bonus content determination table according to the second embodiment will now be described in detail while referring to the drawings. FIG. 22 is an explanatory diagram showing the bonus content determination table according to the second embodiment.

As shown in FIG. 22, the bonus content determination table according to the second embodiment includes associations between the plurality of pay lines set with respect to the variable display portion 3B and the number of free games to be added.

For instance, “ADD 40 FREE GAMES (e.g., number of free games: +40)” is associated with the first pay line L1, and “ADD 15 FREE GAMES (e.g., number of free games: +15)” is associated with the fourth pay line L4 (refer to FIG. 22).

Accordingly, after identifying the bonus target line based on the code numbers of the reel display portions 101 through 105 and the setting status of the activated pay line, the main CPU 42 can identify the contents of the bonus game (specifically, the number of free games) in the current game based on the bonus target line and the bonus content determination table (refer to FIG. 22).

Here, the bonus contents determination process according to the second embodiment will be described in detailed based on a specific example.

In this specific example, the seventh pay line L5 is assumed to be an activated pay line. The BONUS symbol 45G is stopped on the symbol display areas 111C, 112A, 113C, 114A and 115C constituting the seventh pay line L5, establishing a special symbol combination. The main CPU 42 can identify the above condition by referring to the code numbers of the reel display portions 101 through 105 and the setting status of the activated pay line.

In this case, a special symbol combination is established on the seventh pay line L5 which is the activated pay line. Thus, the seventh pay line L5 corresponds to the bonus target line. Once the bonus target line is identified, the main CPU 42 refers to the bonus content determination table according to the second embodiment. As shown in FIG. 22, in the bonus content determination table according to the second embodiment, “ADD 35 FREE GAMES” is associated with the seventh pay line L5. Accordingly, the main CPU 42 adds the number of free games associated with the bonus target line with respect to the “number of standard free games: 5”. Specifically, in this case, the main CPU 42 sets the number of free games in the current game to “40”.

After the number of free games in the current game is determined based on the bonus target line and the bonus content determination table (refer to FIG. 2), the main CPU 42 stores the number of free games thus determined in the RAM 43. Then, the main CPU 42 shifts the process to the bonus game process (S19).

If a plurality of activated pay lines correspond to the bonus target line, the main CPU 42 determines the number of free games in the current game by accumulatively adding the number of free games associated to each bonus target line to the number of standard free games.

At the subsequent step S19, the main CPU 42 executes the bonus game process. In this bonus game process (S19), the main CPU 42 executes the so-called free game by the number of times determined in the bonus content determination process (S18). Then, the main CPU 42 awards to the player a prize based on the results of the free game.

The bonus game process has already been described in detail in the first embodiment, and therefore, further description thereof is omitted. Once the bonus game process (S19) is ended, the main CPU 42 ends the main game process program.

As was described earlier, according to the slot machine 1 of the second embodiment, if a special symbol combination consisted of the BONUS symbol 45G is stopped on the activated pay line, a “free game” is awarded to the player as a bonus. That is, the player can easily judge the presence or absence of the “free game” based on “establishment or non-establishment of a special symbol combination on the activated pay line”. Accordingly, the slot machine 1 helps the player easily judge the “presence or absence of a free game”. As a result, the slot machine 1 assuredly raises the interest of a player by awarding the free game.

In the bonus content determination process (S18), the slot machine 1 according to the second embodiment awards the number of free games which differs depending on the state of the activated pay line on which the special symbol combination consisted of the BONUS symbols 45G is established. Thus, the player can no longer easily grasp the number of free games he/she is awarded. Accordingly, the gaming machine can offer to the player interest such as surprise with respect to the number of free games he/she will be awarded.

Here, each pay line is defined so as to include one symbol display area from amongst the symbol display areas constituting the respective reel display portions 101 through 105. A special symbol combination is constituted of BONUS symbols 45G. Accordingly, it can be said that the slot machine 1 according to the second embodiment “awards a number of free games that differs in accordance with the positioning pattern of the BONUS symbols 45B which are stopped on the variable display portion 3B”.

The number of free games which are awarded changes in accordance with the state of the activated pay line in the variable display portion 3B on which the special symbol combination consisted of the BONUS symbol 45G is established. Thus, the slot machine 1 of the second embodiment can add the diversity with respect to the contents of the prize which is awarded as a bonus.

Further, according to the slot machine 1, a sense of superiority can be experienced by a player who knows, and likewise, a player who does not know, the associations between the number of free games to be awarded and the positioning patterns of the BONUS symbols 45G. This sense of superiority comes from the ability of the player to quickly grasp the number of free games he/she will be awarded. As a result, the slot machine 1 can raise the interest of the players who know the above-mentioned associations, in the game.

In the slot machine 1 according to the second embodiment, the contents of the prize to be awarded in accordance with a state of the activated pay line wherein a special symbol combination including the BONUS symbols 45G is established includes a differing number of free games. That is, the contents of the bonuses in the slot machine 1 are unified to “free game”. Accordingly, the slot machine 1 clearly gives the player(s) the impression that diverse bonuses are offered. As a result, the slot machine 1 can raise the player's interest in the game.

The present invention is not limited to the first and second embodiments, and various improvements and modifications can be made thereto without departing from the spirit of the present invention.

For instance, in the first and second embodiments, a description was given of the case that a “free game” is awarded as a bonus game. However, the embodiments are not limited to this aspect. That is, the present invention can be applied to a variety of prizes to be awarded as bonuses.

A “multiple-choice bonus game” can be adopted in place of the “free game”. In this case, the contents of the special prize which changes in accordance with the positioning pattern of the BONUS symbol 45G may be changed from the “number of free games” to the “number of times for the multiple choices”. Similarly, a “bonus for awarding a payout such as a JACKPOT, etc.” can also be applied. In this case, the contents of the special prize which is changed in accordance with the positioning patterns of the BONUS symbols 45G may be changed from “the number of free games” to a “ratio of the amount to be awarded to the player with respect to a certain payout amount (for instance, 80% of the JACKPOT accumulated amount)”.

In the first embodiment, the slot machine determines the number of free games to be awarded to the player by accumulatively adding, all the numbers of free games which are associated with the symbol display areas on which the BONUS symbols 45G have been stopped, in the bonus content determination process (S18). However, the invention is not limited to this aspect. For instance, a maximum value of the number of free games which are associated with the respective symbol display areas, from amongst the symbol display areas onto which the BONUS symbols 45G are stopped can also be handled as the number of free games in the current game.

Similarly, in the second embodiment, in a case where a plurality of bonus target lines exist, the slot machine determines the number of free games in the current game by accumulatively adding the number of free games which is associated with each of bonus target lines. However, a maximum value of the number of free games which is associated with a bonus target line from amongst the plurality of bonus target lines can also be handled as the number of free games in the current game.

In the first and second embodiments, the slot machine determines the number of free games with respect to the current game by adding to the “number of standard free games: 5” the number of free games based on the positioning pattern of the BONUS symbols 45G, or alternatively, the number of free games based on the pattern of the activated pay line onto which the special symbol combination is established. However, the present invention is not limited to this aspect. Specifically, the slot machine may determine the number of free games with respect to the current game except for the number of standard free games. In other words, the slot machine may determine the number of free games with respect to the current game based only on the number of free games in accordance with the positioning pattern of the BONUS symbols 45G, or alternatively, the number of free games in accordance with the pattern of the activated pay line on which the special symbol combination is established.

The present invention can also be realized as a game method for executing the above-mentioned processes. Further, the present invention can also be realized as a program which causes a computer to execute the game method, and as a record medium onto which this program is recorded.

What is claimed is:

1. A gaming machine having:
a display onto which a symbol display area and a symbol display portion are displayed, the symbol display area displaying a plurality of types of symbols, including a special symbol, in a variable manner and stopped manner; and the symbol display portion being composed of a plurality of symbol display areas arranged in a matrix; and
a processor which executes processes as follows:
(a) a process of betting a gaming value and setting an activated pay line which is a target of the bet, from amongst a plurality of pay lines made up to include individual symbol display areas constituting respective columns in the symbol display portion;
(b) a process of executing variable display and stopped display of symbols in the symbol display areas constituting the symbol display portion;
(c) a process of awarding a first prize, if a symbol combination constituted of symbols which are stopped on the activated pay line is a special combination including special symbols, and on condition the activated pay line corresponds to a first pay line; and
(d) a process of awarding a second prize which differs from the first prize, if a symbol combination made up of symbols which are stopped on the activated pay line corresponds to the special combination, and on condition the activated pay line corresponds to a second pay line which differs from the first pay line.

2. The gaming machine according to claim 1, wherein the processor:
awards a predetermined number of free games as a first prize; and
awards a number of free games as a second prize, said number of free games differing from the predetermined number of free games corresponding to the first prize.

3. A gaming machine having:
a display onto which a symbol display area and a symbol display portion are displayed, the symbol display area displaying a plurality of types of symbols, including a special symbol, in a variable manner and stopped manner; and the symbol display portion being composed of a plurality of symbol display areas arranged in a plurality of columns and a plurality of rows; and
a processor which executes processes as follows:
(a) a process of accepting a bet of a gaming value, and executing display of symbols on the respective symbol display areas in a variable manner and stopped manner;
(b) a process of counting the symbols which are stopped on the symbol display portion for each symbol type;
(c) a process of awarding a first prize, in case the number of special symbols is equal to or higher than a predetermined number, and on condition the positioning pattern of the special symbol on the symbol display portion corresponds to a first positioning pattern; and
(d) a process of awarding a second prize which differs from the first prize, in case the number of special symbols is equal to or higher than a predetermined number, and on condition the positioning pattern of the special symbol on the symbol display portion corresponds to a second positioning pattern which differs from the first positioning pattern.

4. The gaming machine according to claim 3, wherein the processor:
awards a predetermined number of free games as a first prize; and
awards a number of free games as a second prize, said number of free games differing from the predetermined number of free games corresponding to the first prize.
